(19) United States
(12) Patent Application Publication
(10) Pub. No.: US 2007/0097030 A1
(43) Pub. Date: May 3, 2007

(54) Plasma display apparatus

(75) Inventor: Seonghak Moon, Seoul (KR)

Correspondence Address: KED & ASSOCIATES, LLP, P.O. Box 221200, Chantilly, VA, 20153-1200, US

(73) Assignee: LG Electronics Inc.

(21) Appl. No.: 11/588,224

(22) Filed: Oct. 27, 2006

(30) Foreign Application Priority Data
Oct. 28, 2005 (KR) 10-2005-0102636

(51) Int. Cl. G09G 3/28

(52) U.S. Cl. 345/66

(57) ABSTRACT

A plasma display apparatus is disclosed. The plasma display apparatus includes a voltage supply unit, a voltage storing unit, and a voltage path selection unit. The voltage supply unit supplies a positive voltage to the data electrode during an address period. The voltage storing unit is formed between the data electrode and the voltage supply unit, and stores a voltage supplied by the voltage supply unit. The voltage path selection unit forms a supply path of the positive voltage which the voltage supply unit supplies to the voltage storing unit or the data electrode.

This Nonprovisional application claims priority under 35 U.S.C. § 119(a) on patent application Ser. No. 10-2005-0102636 filed in Korea on Oct. 28, 2005 the entire contents of which are hereby incorporated by reference.

### BACKGROUND

1. Field

This document relates to a plasma display apparatus.

2. Description of the Related Art

A plasma display panel comprises a front panel, a rear panel and barrier ribs formed between the front panel and the rear panel. The barrier ribs forms unit discharge cell or discharge cells. Each of discharge cells is filled with an inert gas containing a main discharge gas such as neon (Ne), helium (He) and a mixture of Ne and He, and a small amount of xenon (Xe). The plurality of discharge cells form one pixel. For example, a red (R) discharge cell, a green (G) discharge cell, and a blue (B) discharge cell form one pixel.

When a high frequency voltage is supplied to the discharge cell, the inert gas generates vacuum ultraviolet rays, which thereby cause a phosphor formed between the barrier ribs to emit light, thus displaying an image.

The plasma display panel comprises a plurality of electrodes, for example, a scan electrode, a sustain electrode and a data electrode, and drivers for supplying driving voltages to the electrodes of the plasma display panel are connected to each electrode such that a plasma display apparatus is formed.

Each driver supplies a reset pulse during a reset period, a scan pulse and a data pulse during an address period, a sustain pulse during a sustain period to the electrodes of the plasma display panel, thereby displaying an image. Since the plasma display apparatus can be thin and light, it has attracted attention as a next generation display device.

There is a problem in that a data driver for driving the data electrode is weak to heat. This problem is more serious depending on an operation of a switching element included in a data driver IC which drives the data electrode by supplying a data pulse to the data electrode during the address period.

In other words, a displacement current is generated due to a change in a state of a voltage supplied to the data electrode such that the heat is generated in the data driver. The heat or the displacement current accelerates a damage to a circuit of the data driver and impedes driving characteristics of the circuit.

Further, a magnitude of the voltage which the data driver supplies to the data electrode is important for an operation characteristic of the data driver. When the voltage supplied by the data driver, for example, an absolute values of a voltage of the data pulse supplied during the address period is high, the manufacturing cost and power consumption increase by the use of elements having a high-level withstanding voltage characteristic.

Furthermore, the driving of the data driver at a high voltage level increases a bad influence on the above-described data driver weak to heat such that a damage to the circuit of the above-described data driver is more serious and life span of the plasma display panel is reduced.

Further, in a case where the driving voltage is high, factors affecting the image quality, for example, a state of a phosphor is fixed. This results in a reduction in the quality of the image displayed on the plasma display panel

### SUMMARY

In one aspect, a plasma display apparatus comprises a plasma display panel comprising a data electrode, a voltage supply unit for supplying a positive voltage to the data electrode during an address period, a voltage storing unit, formed between the data electrode and the voltage supply unit, for storing a voltage supplied by the voltage supply unit, and a voltage path selection unit for forming a supply path of the positive voltage which the voltage supply unit supplies to the voltage storing unit or the data electrode.

In another aspect, a plasma display apparatus comprises a plasma display panel comprising a data electrode, a voltage supply unit for supplying a positive voltage to the data electrode during an address period, a voltage storing unit, formed between the data electrode and the voltage supply unit, for storing a voltage supplied by the voltage supply unit, a voltage path selection unit for forming a supply path of the positive voltage which the voltage supply unit supplies to the voltage storing unit or the data electrode, and a driving signal output unit, formed between the voltage storing unit and the data electrode in the form of a driver integrated circuit, for controlling the output of a voltage supplied to the data electrode.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention.

FIG. 1 illustrates an example of a plasma display apparatus according to an embodiment;

FIG. 2 illustrates an example of a plasma display panel of the plasma display apparatus according to the embodiment;

FIG. 3 illustrates an example of a method for achieving a gray level of an image of the plasma display apparatus according to the embodiment;

FIG. 4 illustrates an example of a driving waveform depending on a method of driving the plasma display apparatus according to the embodiment;

FIG. 5 illustrates an example of a data driver of the plasma display apparatus according to the embodiment;

FIGS. 6a to 6c illustrate an operation order of the data driver of the plasma display apparatus according to the embodiment; and

FIG. 7 illustrates a data pulse and a switch timing depending on the operation of the data driver of FIGS. 6a to 6c.

### DETAILED DESCRIPTION OF PREFERRED EMBODIMENTS

Reference will now be made in detail embodiments of the invention examples of which are illustrated in the accompanying drawings.

A plasma display apparatus comprises a plasma display panel comprising a data electrode, a voltage supply unit for supplying a positive voltage to the data electrode during an address period, a voltage storing unit, formed between the data electrode and the voltage supply unit, for storing a voltage supplied by the voltage supply unit, and a voltage path selection unit for forming a supply path of the positive voltage which the voltage supply unit supplies to the voltage storing unit or the data electrode.

The voltage supply unit may include a single voltage source for supplying the positive voltage, which is substantially one half a magnitude of a voltage of a data pulse supplied during the address period, to the data electrode.

The voltage path selection unit may cause a sum of the positive voltage supplied by the voltage supply unit and a voltage stored in the voltage storing unit to be supplied to the data electrode through a predetermined switching operation during the address period.

The voltage path selection unit may comprise a first switch, a second switch, and a first diode. One terminal of the first switch may be commonly connected to the voltage supply unit and an anode terminal of the first diode, and the other terminal of the first switch may be commonly connected to one terminal of the second switch, the other terminal of the voltage storing unit, and one terminal of the data electrode. One terminal of the voltage storing unit may be commonly connected to a cathode terminal of the first diode and the other terminal of the data electrode.

The plasma display apparatus may further comprise a ground level voltage supply unit, connected to the other terminal of the second switch, for supplying a ground level voltage to the data electrode.

The voltage storing unit may comprise a capacitor.

The voltage storing unit may comprise a single capacitor.

When the second switch of the voltage path selection unit is turned on, the voltage storing unit is charged to the positive voltage supplied by the voltage supply unit.

When the first switch of the voltage path selection unit is turned on, the positive voltage may be supplied to one terminal of the data electrode, and a voltage substantially equal to two times a magnitude of the positive voltage may be supplied to the other terminal of the data electrode.

A magnitude of a voltage of the data pulse supplied to the data electrode during the address period may be substantially two times a magnitude of the positive voltage.

A plasma display apparatus comprises a plasma display panel comprising a data electrode, a voltage supply unit for supplying a positive voltage to the data electrode during an address period, a voltage storing unit, formed between the data electrode and the voltage supply unit, for storing a voltage supplied by the voltage supply unit, a voltage path selection unit for forming a supply path of the positive voltage which the voltage supply unit supplies to the voltage storing unit or the data electrode, and a driving signal output unit, formed between the voltage storing unit and the data electrode in the form of a driver integrated circuit, for controlling the output of a voltage supplied to the data electrode.

The voltage supply unit may comprise a single voltage source for supplying the positive voltage, which is substantially one half a magnitude of a voltage of a data pulse supplied during the address period, to the data electrode.

The voltage path selection unit may cause a sum of the positive voltage supplied by the voltage supply unit and a voltage stored in the voltage storing unit to be supplied to the data electrode through a predetermined switching operation during the address period.

The voltage path selection unit may comprise a first switch, a second switch, and a first diode. The driving signal output unit may comprise a third switch and a fourth switch which are connected to each other in a push-pull manner. The data electrode may be connected between the third switch and the fourth switch. The driving signal output unit may control the output of a voltage supplied to the data electrode through a predetermined switching operation.

One terminal of the first switch may be commonly connected to the voltage supply unit and an anode terminal of the first diode. The other terminal of the first switch may be commonly connected to one terminal of the second switch, the other terminal of the voltage storing unit and one terminal of the fourth switch of the driving signal output unit. One terminal of the voltage storing unit may be commonly connected to a cathode terminal of the first diode and one terminal of the third switch of driving signal output unit.

The plasma display apparatus may further comprise a ground level voltage supply unit, connected to the other terminal of the second switch, for supplying a ground level voltage to the data electrode.

The voltage storing unit may comprise a capacitor.

The voltage storing unit may comprise a single capacitor.

When the second switch of the voltage path selection unit is turned on, the voltage storing unit may be charged to the positive voltage supplied by the voltage supply unit.

When the first switch of the voltage path selection unit is turned on, the positive voltage may be supplied to one terminal of the fourth switch of the driving signal output unit, and a voltage substantially equal to two times the positive voltage may be supplied to one terminal of the third switch of the driving signal output unit.

Hereinafter, exemplary embodiments will be described in detail with reference to the attached drawings.

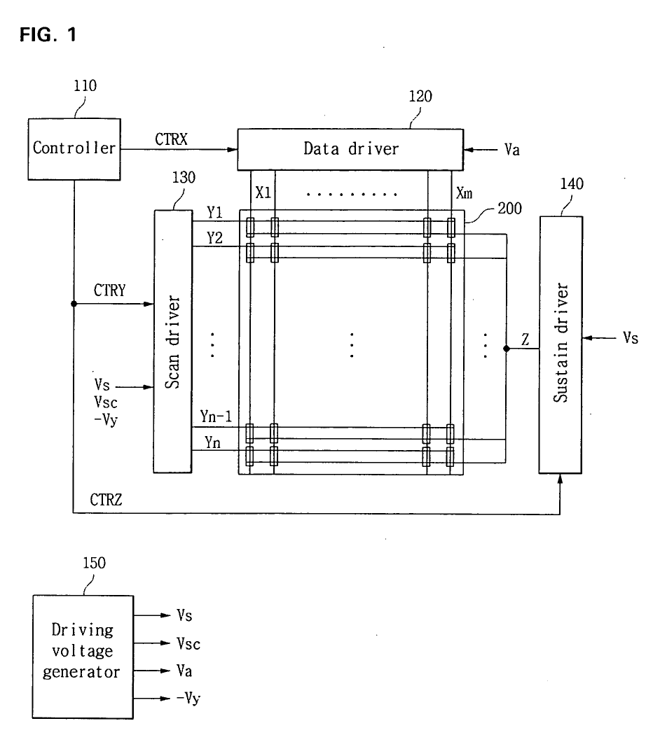

FIG. 1 illustrates an example of a plasma display apparatus according to an embodiment.

As illustrated in FIG. 1, the plasma display apparatus according to the embodiment comprises a plasma display panel 200, drivers 120, 130 and 140 for driving electrodes formed in the plasma display panel 200, a controller 110 for controlling the drivers 120, 130 and 140, and a driving voltage generator 150 for generating necessary voltages of the drivers 120, 130 and 140.

The driver comprises a data driver 120 for supplying data to data electrodes X1 to Xm, a scan driver 130 for driving scan electrodes Y1 to Yn, and a sustain driver 140 for driving sustain electrodes Z being common electrodes.

The plasma display panel 200 comprises a front substrate (not shown) and the rear substrate, which are coalesced with each other at a given distance. On the front substrate, a plurality of electrodes, for example, the scan electrodes Y1 to Yn and the sustain electrodes Z are formed in pairs. On the rear substrate, the data electrodes X1 to Xm are formed to intersect the scan electrodes Y1 to Yn and the sustain electrodes Z.

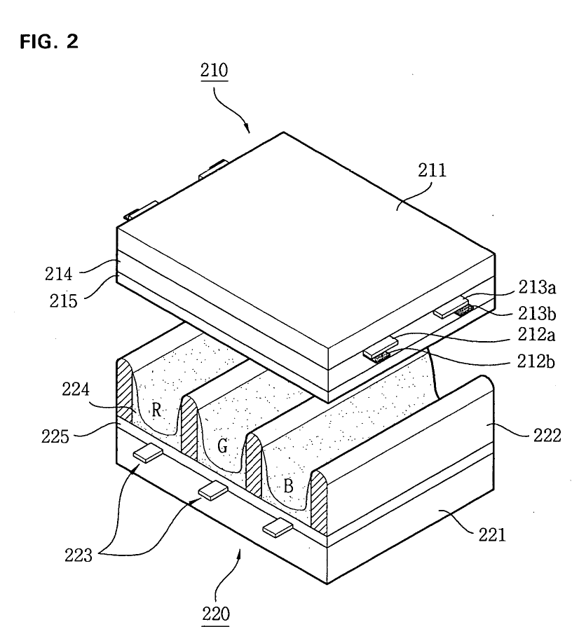

The following is a detailed description of the structure of the plasma display panel 200, with reference to FIG. 2.

FIG. 2 illustrates an example of a plasma display panel of the plasma display apparatus according to the embodiment.

As illustrated in FIG. 2, the plasma display panel 200 comprises a front panel 210 and a rear panel 220 which are coupled in parallel to oppose to each other at a given distance therebetween. The front panel 210 comprises a front substrate 211 which is a display surface. The rear panel 220 comprises a rear substrate 221 constituting a rear surface. A plurality of scan electrodes 212 and a plurality of sustain electrodes 213 are formed in pairs on the front substrate 211, on which an image is displayed, to form a plurality of maintenance electrode pairs. A plurality of data electrodes 223 are arranged on the rear substrate 221 to intersect the plurality of maintenance electrode pairs.

The scan electrode 212 and the sustain electrode 213 each comprise transparent electrodes 212a and 213a made of a transparent indium-tin-oxide (ITO) material and bus electrodes 212b and 213b made of a metal material. The scan electrode 212 and the sustain electrode 213 each may comprise either the transparent electrode or the bus electrode. The scan electrode 212 and the sustain electrode 213 generate a mutual discharge therebetween in one discharge cell and maintain light-emissions of discharge cells. The scan electrode 212 and the sustain electrode 213 are covered with one or more upper dielectric layers 214 to limit a discharge current and to provide insulation between the maintenance electrode pairs. A protective layer 215 with a deposit of MgO is formed on an upper surface of the upper dielectric layer 204 to facilitate discharge conditions.

A plurality of stripe-type or well-type barrier ribs 222 are formed on the rear substrate 221 of the rear panel 220 to form a plurality of discharge spaces, i.e., a plurality of discharge cells. The plurality of data electrodes 223 for performing an address discharge to generate vacuum ultraviolet rays are arranged in parallel to the barrier ribs 222. An upper surface of the rear substrate 221 is coated with Red (R), green (G) and blue (B) phosphors 224 for emitting visible light for an image display when the address discharge is performed. A lower dielectric layer 225 is formed between the data electrodes 223 and the phosphors 224 to protect the data electrodes 223.

The front panel 210 and the rear panel 220 thus formed are coalesced by a sealing process such that the plasma display panel is completed. The drivers for driving the scan electrode 212, the sustain electrode 213, and the data electrode 223 are adhered to the plasma display panel to complete the plasma display apparatus.

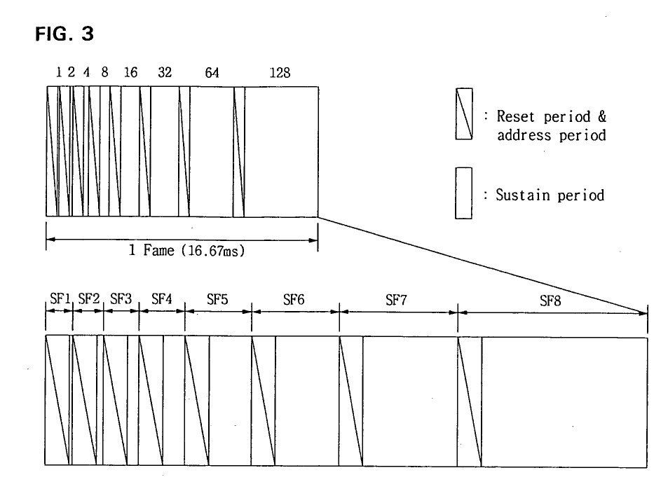

The following is a detailed description of a manner for driving the plasma display apparatus according to the embodiment, with reference to FIG. 3.

FIG. 3 illustrates an example of a method for achieving a gray level of an image of the plasma display apparatus according to the embodiment.

As illustrated in FIG. 3, the plasma display apparatus is driven with a frame being divided into several subfields having a different number of emission times. For example, each of the subfields is subdivided into a reset period for initializing all the cells, an address period for selecting cells to be discharged, and a sustain period for representing gray scale in accordance with the number of discharges.

For example, if an image with 256-level gray scale is to be displayed, a frame period (for example, 16.67 ms) corresponding to 1/60 sec is divided into eight subfields SF1 to SF8. Each of the eight subfields SF1 to SF8 is subdivided into a reset period, an address period, and a sustain period. A duration of the reset period in a subfield is equal to a duration of the reset periods in the other subfields. A duration of the address period in a subfield is equal to a duration of the address periods in the other subfields. However, a duration of the sustain period of each subfield may be different from one another, and the number of sustain pulses assigned during the sustain period of each subfield may be different from one another. For example, the sustain period increases in a ratio of 2ⁿ (where, n=0, 1, 2, 3, 4, 5, 6, 7) in each of the subfields such that a gray level of an image is represented.

The basic panel structure and the method for achieving the gray level of the image of the plasma display apparatus have been so far described. The description of the plasma display apparatus succeeds with reference to FIG. 1

The scan driver 130, under the control of the controller 110, supplies a reset pulse to the scan electrodes Y1 to Yn during the reset period. The reset pulse initializes a state of wall charges formed within all the discharge cells in a previous subfield, and includes a setup pulse and a set-down pulse.

The scan driver 130, under the control of the controller 110, consecutively supplies scan pulses to the scan electrodes Y1 to Yn during the address period. The scan pulse is maintained at a constant voltage level, and then falls to a scan voltage—Vy.

The scan driver 130, under the control of the controller 110, supplies a pulse with a sustain voltage Vs to the scan electrodes Y1 to Yn during the sustain period.

The data driver 120 receives data mapped for each subfield by a subfield mapping circuit (not illustrated) after being inverse-gamma corrected and error-diffused through an inverse gamma correction circuit (not illustrated) and an error diffusion circuit (not illustrated), or the like. The data driver 120 samples and latches the mapped data, and then supplies a data pulse to the data electrodes Xl to Xm in response to a timing control signal CTRX of the controller 110. The supplying of the data pulse selects a discharge cell to be turned on or off, i.e., a discharge cell where will generate a sustain discharge during the sustain period.

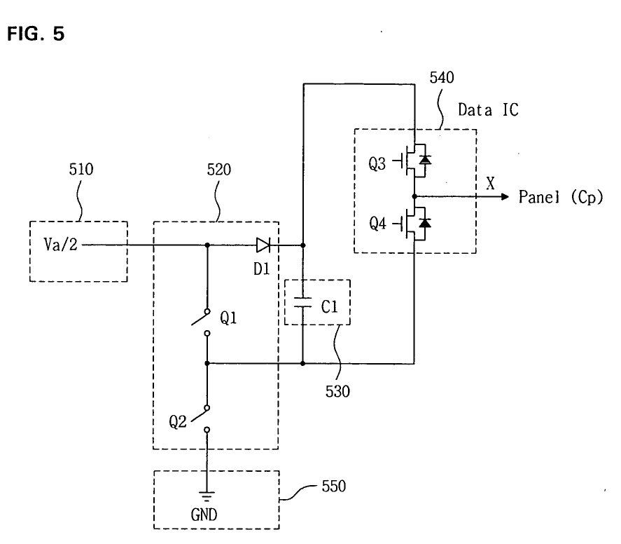

A sustain pulse which will be described later is supplied to the discharge cell selected by supplying the data pulse during the sustain period such that wall charges are formed to the extent that a sustain discharge can occur. The data driver 120 of the plasma display apparatus according to the embodiment can supply the data pulse of a low voltage level. This will be described in detail later with reference to FIG. 5.

The sustain driver 140 supplies a positive voltage to the sustain electrodes Z during at least one of the set-down period and the address period.

The sustain driver 140 supplies a pulse with the sustain voltage Vs to the sustain electrodes Z during the sustain period using a sustain driving circuit installed inside the sustain driver 140. The pulses with the sustain voltage Vs are alternately supplied to the scan electrodes and the sustain electrodes.

The controller 110 receives a vertical/horizontal synchronization signal and a clock signal, and generates timing control signals CTRX, CTRY and CTRZ for controlling the operation timing and synchronization of each driver 120, 130 and 140 during the reset period, the address period and the sustain period. The controller 110 supplies the timing control signals CTRX, CTRY and CTRZ to the corresponding drivers 120, 130 and 140 to control each of the drivers 120, 130 and 140.

The data control signal CTRX includes a sampling clock for sampling data, a latch control signal, and a switch control signal for controlling the on/off time of an energy recovery circuit and a driving switch element. The scan control signal CTRY includes a switch control signal for controlling the on/off time of the energy recovery circuit and the driving switch element inside the scan driver 130. The sustain control signal CTRZ includes a switch control signal for controlling the on/off time of the energy recovery circuit and the driving switch element inside the sustain driver 140.

The driving voltage generator 150 generates a setup voltage. Vsetup, a scan reference voltage Vsc, a scan voltage—Vy, a sustain voltage Vs, and a data voltage Vd, and the like. These driving voltages may vary with the composition of a discharge gas or the structure of the discharge cells.

It should be noted that only one example of the configuration of the plasma display apparatus according to the embodiment has been illustrated and described above, and the present invention is not limited to the plasma display apparatus of the above-described configuration.

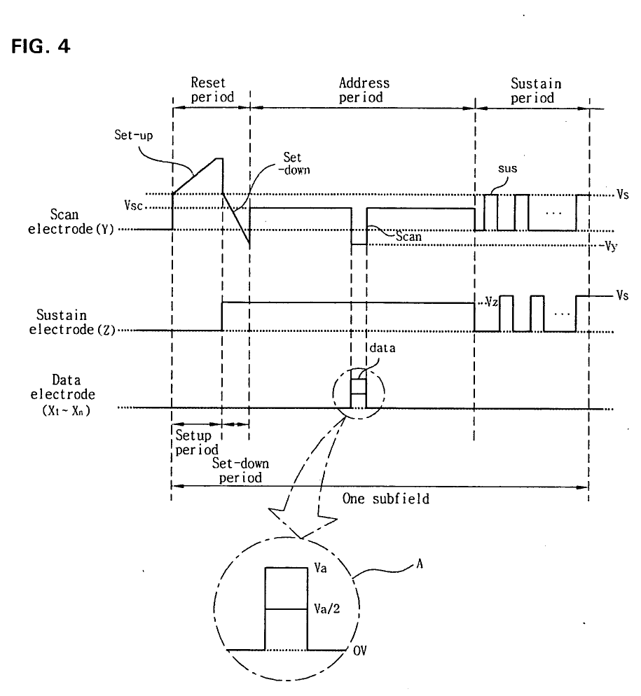

The following is a detailed description of a driving waveform generated in the drivers 120, 130 and 140 of the plasma display apparatus according to the embodiment, with reference to FIG. 4.

FIG. 4 illustrates an example of a driving waveform depending on a method of driving the plasma display apparatus according to the embodiment.

As illustrated in FIG. 4, the plasma display apparatus is driven with a frame of the screen being divided into a plurality of subfields. Each subfield is divided into a reset period for initializing all the cells, an address period for selecting cells to be discharged, and a sustain period for holding the selected cells in a discharge state. Further, if necessary, an erase period for erasing wall charges within the discharged cell may be added.

The reset period is further divided into a setup period and a set-down period. During the setup period, a setup pulse (Set-up) is simultaneously supplied to all the scan electrodes Y. The setup pulse (Set-up) generates a weak dark discharge (i.e., a setup discharge) within the discharge cells of the whole screen. This results in wall charges of a positive polarity being accumulated on the data electrodes X and the sustain electrodes Z, and wall charges of a negative polarity being accumulated on the scan electrodes Y.

During the set-down period, a set-down pulse (Set-down), which falls from a positive voltage lower than the highest voltage of the setup pulse (Set-up) to a given voltage lower than a ground level voltage, is supplied to the scan electrodes Y, thereby generating a weak erase discharge within the discharge cells. Furthermore, the remaining wall charges are uniform inside the discharge cells to the extent that the address discharge can be stably performed.

During the address period, a scan pulse (Scan) of a negative polarity is sequentially supplied to the scan electrodes Y and, at the same time, a data pulse (data) of a positive polarity synchronized with the scan pulse (Scan) is supplied to the data electrodes X. As the voltage difference between the scan pulse (Scan) and the data pulse (data) is added to the wall voltage generated during the reset period, the address discharge occurs within the discharge cells to which the data pulse (data) is supplied. Wall charges are formed inside the cells selected by performing the address discharge such that when a sustain voltage Vs is applied a discharge occurs.

The address discharge occurs due to the supplying of the data pulse (data). While the above-described scan pulse is sequentially supplied to all the discharge cells, the data pulse is supplied to only the discharge cells where the sustain discharge will occur. Therefore, the supplying of the data pulse selects the discharge cells to be turned on.

In a driving method of the data pulse illustrated by a circle A in FIG. 4, a voltage Va of the data pulse is supplied to the data electrode X in a state in which a voltage of the data electrode X is maintained at a first positive voltage level (for example, a voltage Va/2). Since a voltage supplied to a data driver IC for driving the data electrode is reduced by improving the driving method of the data pulse, the data driver can be driven at a low voltage level. Thus, power consumption is minimized. This will be described in detail later with reference to FIG. 5.

During the sustain period, a sustain pulse (sus) is alternately supplied to the scan electrode Y and the sustain electrode Z. As the wall voltage within the cells selected by performing the address discharge is added to the sustain pulse, every time the sustain pulse is supplied, a sustain discharge, i.e., a display discharge is generated in the cells selected during the address period.

If the erase period for erasing wall charges within the discharged cells is added after the sustain discharge is completed, during the erase period, an erase pulse having a small pulse width and a low voltage level is supplied to the sustain electrode such that the remaining wall charges within the cells of the whole screen are eased.

It should be noted that only one example of the driving waveform for helping the understanding of the configuration of the embodiment has been illustrated and described above, and the configuration of the embodiment is not limited to the above-described driving waveform. In other words, although a driving waveform different from the above-described driving waveform is generated, it is included in the embodiment in a case where a driving method of a data pulse of the driving waveform is the same.

The following is a detailed description of the driver and a driving method of the data electrode, with reference to FIG. 5.

FIG. 5 illustrates an example of a data driver of the plasma display apparatus according to the embodiment.

More specifically, FIG. 5 illustrates the configuration of a circuit for driving the data pulse in the data driver of the plasma display apparatus according to the embodiment. The data driver comprises a voltage supply unit 510, a voltage storing unit 530, and a voltage path selection unit 520. The data driver may further comprise a driving signal output unit 540 and a ground level voltage supply unit 550.

The voltage supply unit 510 supplies a positive voltage to the data electrode X during the address period. The voltage supply unit 510 may supply a positive voltage Va/2, which is substantially one half a magnitude of a voltage of a data pulse supplied during the address period, to the data electrode X. The voltage supply unit 510 may be formed in the form of a single voltage source such that the data pulse may be supplied to the data electrode X.

The voltage storing unit 530 is formed between the data electrode X and the voltage supply unit 510. The voltage storing unit 530 comprises a single capacitor C1 to store a voltage. The voltage storing unit 530 stores the positive voltage supplied by the voltage supply unit 510. The voltage stored in the voltage storing unit 530 may be supplied to the data electrode X. For example, the voltage Va/2 stored in the voltage storing unit 530 is supplied to the data electrode X, and then a second voltage Va being the voltage of the data pulse is supplied to the data electrode X.

More specifically, the voltage storing unit 530 is charged to a voltage substantially equal to one half the magnitude of the voltage of the data pulse which the voltage supply unit 510 comprising the single voltage source supplies. Then, the charging voltage Va/2 to the voltage storing unit 530 is supplied to the data electrode X. The voltage of the voltage supply unit 510, i.e., the voltage Va/2 equal to one half the data pulse is supplied to the data electrode X in a state in which a voltage of the data electrode X is maintained at the voltage Va/2 equal to one half the magnitude of the voltage of the data pulse. Accordingly, the voltage Va/2 stored in the voltage storing unit 530 is added to the voltage Va/2 of the voltage supply unit 510 such that the voltage Va of the data pulse is supplied to the data electrode X.

The voltage path selection unit 520 selects one path of a first path and a second path through a predetermined switching operation. The first path is used to supply the positive voltage from the voltage supply unit 510 to the voltage storing unit 530. The second path is used to supply the positive voltage from the voltage supply unit 510 to the data electrode X. The voltage path selection unit 520 causes a sum of the voltage supplied by the voltage supply unit 510 and the voltage stored in the voltage storing unit 530 to be supplied to the data electrode X during the address period. The voltage path selection unit 520 comprises a first switch Q1, a second switch Q2, and a first diode D1.

The driving signal output unit 540 is formed between the voltage storing unit 530 and the data electrode X in the form of a driver integrated circuit. The driving signal output unit 540 controls the output of the voltages supplied to the data electrode X. For example, the driving signal output unit 540 comprises a third switch Q3 and a fourth switch Q4 which are connected to each other in a push-pull manner. The data electrode is connected between the third switch Q3 and the fourth switch Q4 such that the driving signal output unit 540 controls the output of voltages supplied to the data electrode X through a predetermined switching operation.

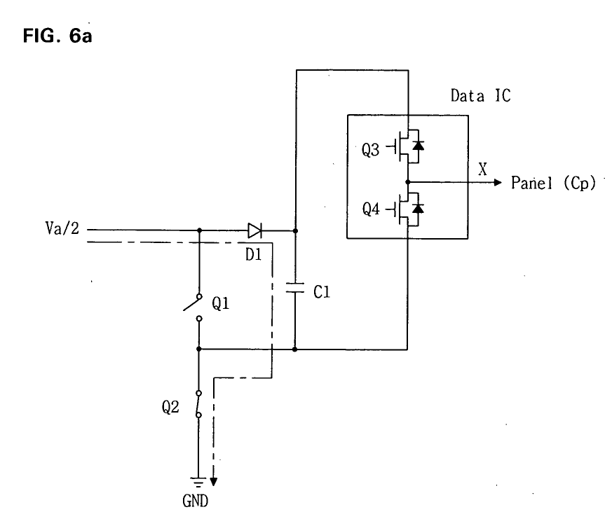

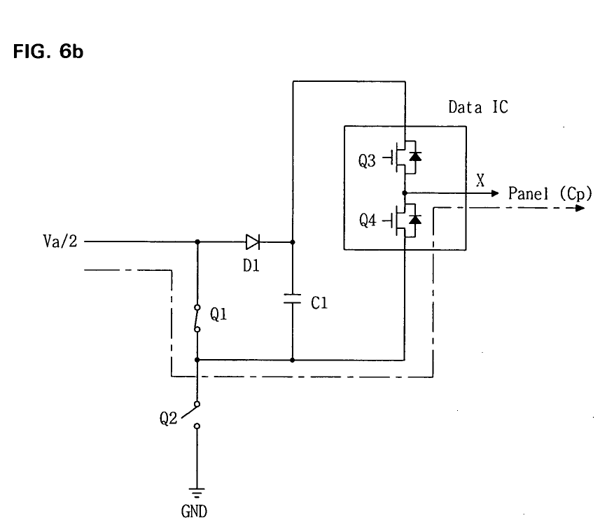

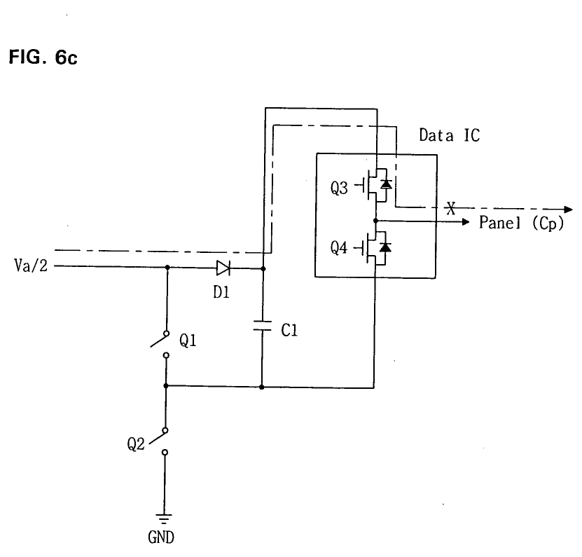

One terminal of the first switch Q1 of the voltage path selection unit 520 is commonly connected to the voltage supply unit 510 and an anode terminal of the first diode D1. The other terminal of the first switch Q1 is commonly connected to one terminal of the second switch Q2, the other terminal of the voltage storing unit 530 (i.e., the capacitor C1), and one terminal of the data electrode X (i.e., one terminal of the fourth switch Q4 of the driving signal output unit 540). One terminal of the voltage storing unit (i.e., the capacitor C1) is commonly connected to a cathode terminal of the first diode D1 and the other terminal of the data electrode X (i.e., one terminal of the third switch Q3 of the driving signal output unit 540). An operation path of the circuit of the data driver for supplying the data pulse to the data electrode will be described later with reference to FIGS. 6a to 6c.

The ground level voltage supply unit 550 is connected to the other terminal of the second switch Q2 of the voltage path selection unit 520, and supplies a ground level voltage to the data electrode X.

The following is a detailed description of a circuit operation of the data driver according to the embodiment, with reference to FIGS. 6a to 6c.

FIGS. 6a to 6c illustrate an operation order of the data driver of the plasma display apparatus according to the embodiment.

As illustrated in FIG. 6a, when the second switch Q2 of the voltage path selection unit 520 is turned on, the voltage storing unit 530 is charged to the positive voltage (i.e., the voltage Va/2 equal to one half the data pulse) supplied by the voltage supply unit 510 through the first path passing through the first diode D1, the voltage storing unit 530, the second switch Q2, and the ground level supply unit 550.

Next, as illustrated in FIG. 6b, when the second switch Q2 is turned off and the first switch Q1 of the voltage path selection unit 520 is turned on, the positive voltage Va/2 supplied by the voltage supply unit 510 is supplied to the other terminal (i.e., a lower terminal) of the voltage storing unit 530 through the first switch Q1. Thus, the positive voltage Va/2 is supplied to one terminal of the data electrode X (i.e., one terminal of the fourth switch Q4 of the driving signal output unit 540).

At the same time, as illustrated in FIG. 6c, the voltage supply unit 510 supplies the positive voltage Va/2 through the first diode D1. Then, the voltage Va of the data pulse adding the positive voltage Va/2 supplied by the voltage supply unit 510 and the charging voltage Va/2 to the voltage storing unit 530 is supplied between a cathode terminal of the first diode D1 and one terminal (i.e., an upper terminal) of the voltage storing unit 530. The voltage Va of the data pulse is supplied to the data electrode X through the other terminal of the data electrode X (i.e., one terminal (i.e., an upper terminal) of the third switch Q3 of the driving signal output unit 540).

As above, a sum of the positive voltage Va/2 supplied by the voltage supply unit 510 and the charging voltage Va/2 to the voltage storing unit 530 is supplied to the data electrode X. While the voltage Va of the data pulse being a practical driving voltage is supplied to a plasma display panel Cp, the voltage Va/2 equal to one half the voltage Va of the data pulse is supplied to both terminals of the data electrode X. Thus, the data driver is driven at a low voltage level.

For example, the voltage Va of the data pulse is supplied to an upper terminal of the driving signal output unit 540 (i.e., the upper terminal of the third switch Q3), and the voltage Va/2 equal to one half the data voltage Va is supplied to a lower terminal of the driving signal output unit 540 (i.e., the lower terminal of the fourth switch Q4). After all, a difference (Va-Va/2) between the data voltage Va and the voltage Va/2 equal to one half the data voltage Va is supplied to the driving signal output unit 540 such that a the driving signal output unit 540 has a low-level withstanding voltage characteristic. In other words, since a low voltage level is supplied to the driving signal output unit 540, a damage to the driving signal output unit 540 is prevented and the manufacturing cost of the plasma display apparatus is reduced by use of the driving signal output unit 540a having the low-level withstanding voltage characteristic.

Furthermore, the circuit configuration of the data driver is simpler than that of the related art data driver, thereby reducing the manufacturing cost of the plasma display apparatus. The driving of the data driver at the low voltage level causes a reduction in power consumption and the prevention of image sticking.

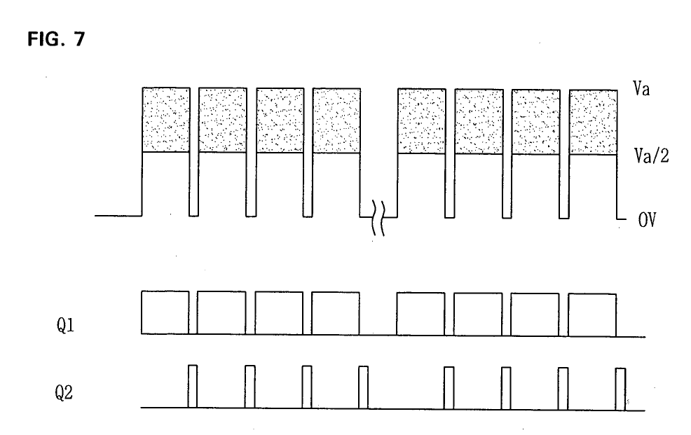

FIGS. 6a to 6c has illustrated and described the unit operation for supplying one data pulse for the understanding of the operation of the plasma display apparatus. FIG. 7 illustrates a switch timing chart depending on the consecutive supplying of the data pulses.

FIG. 7 illustrates a data pulse and a switch timing depending on the operation of the data driver of FIGS. 6a to 6c.

As illustrated in FIG. 7, when the data pulses are consecutively supplied, the unit operations performed in FIGS. 6a to 6c consecutively occur. More specifically, when the second switch Q2 is turned on, the voltage Va/2 equal to one half the data voltage Va is charged. Then, when the second switch Q2 is turned off and the first switch Q1 is turned on, a sum of the voltage Va/2 equal to one half the data voltage Va again supplied and the charged voltage Va/2 is supplied to the plasma display panel.

In other words, a voltage of the plasma display panel is maintained at the voltage Va/2 equal to one half the data voltage Va, and then the voltage Va/2 equal to one half the data voltage Va is again supplied such that the data pulses occur. Since the voltage Va of the data pulse is supplied to be divided into two part, the data driver is driven at the low voltage level.

The driving of the data driver at the low voltage level reduces a bad influence on the circuit of the data driver. The driving of the data driver at the low voltage level reduces power consumption and problems caused by the generation of heat is minimized such that the data driver has a good heat resistance without a heat sink. Thus, the manufacturing cost is reduced.

A plurality of voltage sources may maintain a voltage of the data electrode at a first voltage level and then may supply a second voltage to the data electrode. However, the voltage supply unit in the embodiment is a single voltage source for supplying the voltage Va/2 equal to one half the data voltage V a such that the data drive is driven using the voltage Va/2 equal to one half the voltage Va of the data pulse. As a result, power consumption is reduced to one quarter, and a current flowing in the driving signal output unit is reduced to one half such that a damage to the circuit of the data driver is minimized and the driving characteristic is stabilized.

Further, the driving of the data driver at the low voltage level reduces the fixation of factors (for example, the phosphor) affecting a discharge characteristic. Thus, the plasma display apparatus for providing the improved image quality is provided.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus, comprising:
a plasma display panel comprising a data electrode;
a voltage supply unit for supplying a positive voltage to the data electrode during an address period;
a voltage storing unit, formed between the data electrode and the voltage supply unit, for storing a voltage supplied by the voltage supply unit; and
a voltage path selection unit for forming a supply path of the positive voltage which the voltage supply unit supplies to the voltage storing unit or the data electrode.

2. The plasma display apparatus of claim 1, wherein the voltage supply unit includes a single voltage source for supplying the positive voltage, which is substantially one half a magnitude of a voltage of a data pulse supplied during the address period, to the data electrode.

3. The plasma display apparatus of claim 1, wherein the voltage path selection unit causes a sum of the positive voltage supplied by the voltage supply unit and a voltage stored in the voltage storing unit to be supplied to the data electrode through a predetermined switching operation during the address period.

4. The plasma display apparatus of claim 1, wherein the voltage path selection unit comprises a first switch, a second switch, and a first diode,
one terminal of the first switch is commonly connected to the voltage supply unit and an anode terminal of the first diode, and the other terminal of the first switch is commonly connected to one terminal of the second switch, the other terminal of the voltage storing unit, and one terminal of the data electrode, and
one terminal of the voltage storing unit is commonly connected to a cathode terminal of the first diode and the other terminal of the data electrode.

5. The plasma display apparatus of claim 4, further comprising a ground level voltage supply unit, connected to the other terminal of the second switch, for supplying a ground level voltage to the data electrode.

6. The plasma display apparatus of claim 1, wherein the voltage storing unit comprises a capacitor.

7. The plasma display apparatus of claim 6, wherein the voltage storing unit comprises a single capacitor.

8. The plasma display apparatus of claim 4, wherein when the second switch of the voltage path selection unit is turned on, the voltage storing unit is charged to the positive voltage supplied by the voltage supply unit.

9. The plasma display apparatus of claim 4, wherein when the first switch of the voltage path selection unit is turned on, the positive voltage is supplied to one terminal of the data electrode, and a voltage substantially equal to two times a magnitude of the positive voltage is supplied to the other terminal of the data electrode.

10. The plasma display apparatus of claim 9, wherein a magnitude of a voltage of the data pulse supplied to the data electrode during the address period is substantially two times a magnitude of the positive voltage.

11. A plasma display apparatus, comprising:
a plasma display panel comprising a data electrode;
a voltage supply unit for supplying a positive voltage to the data electrode during an address period;
a voltage storing unit, formed between the data electrode and the voltage supply unit, for storing a voltage supplied by the voltage supply unit;
a voltage path selection unit for forming a supply path of the positive voltage which the voltage supply unit supplies to the voltage storing unit or the data electrode; and
a driving signal output unit, formed between the voltage storing unit and the data electrode in the form of a driver integrated circuit, for controlling the output of a voltage supplied to the data electrode.

12. The plasma display apparatus of claim 11, the voltage supply unit comprises a single voltage source for supplying the positive voltage, which is substantially one half a magnitude of a voltage of a data pulse supplied during the address period, to the data electrode.

13. The plasma display apparatus of claim 11, wherein the voltage path selection unit causes a sum of the positive voltage supplied by the voltage supply unit and a voltage stored in the voltage storing unit to be supplied to the data electrode through a predetermined switching operation during the address period.

14. The plasma display apparatus of claim 11, wherein the voltage path selection unit comprises a first switch, a second switch, and a first diode, and
the driving signal output unit comprises a third switch and a fourth switch which are connected to each other in a push-pull manner, the data electrode is connected between the third switch and the fourth switch, and the driving signal output unit controls the output of a voltage supplied to the data electrode through a predetermined switching operation.

15. The plasma display apparatus of claim 14, wherein one terminal of the first switch is commonly connected to the voltage supply unit and an anode terminal of the first diode, and the other terminal of the first switch is commonly connected to one terminal of the second switch, the other terminal of the voltage storing unit and one terminal of the fourth switch of the driving signal output unit, and
one terminal of the voltage storing unit is commonly connected to a cathode terminal of the first diode and one terminal of the third switch of driving signal output unit.

16. The plasma display apparatus of claim 15, further comprising a ground level voltage supply unit, connected to the other terminal of the second switch, for supplying a ground level voltage to the data electrode.

17. The plasma display apparatus of claim 11, wherein the voltage storing unit comprises a capacitor.

18. The plasma display apparatus of claim 17, wherein the voltage storing unit comprises a single capacitor.

19. The plasma display apparatus of claim 15, wherein when the second switch of the voltage path selection unit is turned on, the voltage storing unit is charged to the positive voltage supplied by the voltage supply unit.

20. The plasma display apparatus of claim 15, wherein when the first switch of the voltage path selection unit is turned on, the positive voltage is supplied to one terminal of the fourth switch of the driving signal output unit, and a voltage substantially equal to two times the positive voltage is supplied to one terminal of the third switch of the driving signal output unit.
